(19) United States
(12) Patent Application Publication
(10) Pub. No.: US 2009/0085491 A1
(43) Pub. Date: Apr. 2, 2009

(54) Starter auxillary electrode starting device with an arc gap

(75) Inventor: Bernhard Siessegger, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/918,483

(22) PCT Filed: Apr. 12, 2006
(86) PCT No.: PCT/DE2006/000657

§ 371 Date: May 30, 2008

(30) Foreign Application Priority Data
Apr. 14, 2005 (EP) 05008228.8
May 18, 2005 (DE) 10 2005 023 798.3

(51) Int. Cl. H05B 41/00

(52) U.S. Cl. 315/209 M

(57) ABSTRACT

A device for operating or starting a high-pressure discharge lamp (18), provided with an auxiliary starting electrode (181), includes a voltage-dependent switch member(16), for providing the starting voltage for the high-pressure discharge lamp (18) to the auxiliary starting electrode (181) and the switch threshold voltage of the voltage-dependent switch member (16) is greater than or the same as the starting voltage of the high-pressure discharge lamp (18).

The invention relates to a device for operating or igniting a high-pressure discharge lamp in accordance with the precharacterizing clause of patent claim 1, a lamp base and a lighting system having such a device and a method for operating a high-pressure discharge lamp.

### I. PRIOR ART

Such a device has been disclosed, for example, in WO 98/18297. This laid-open specification describes a pulse ignition device for a high-pressure discharge lamp, which has been provided with an auxiliary ignition electrode, in particular for a vehicle headlight high-pressure discharge lamp. This pulse ignition device has, as the essential components, a spark gap, an ignition capacitor and an ignition transformer. In order to ignite the gas discharge in the high-pressure discharge lamp, the ignition capacitor is charged in order to then be discharged via the spark gap and via the primary winding of the ignition transformer when the breakdown voltage of said spark gap is reached, so that high voltage pulses are induced in the secondary winding of the ignition transformer which are injected into the high-pressure discharge lamp via the auxiliary ignition electrode and result in the gas discharge in the high-pressure discharge lamp being ignited. Once the gas discharge has been ignited, the high-pressure discharge lamp is operated with a high-frequency current of alternating polarity, whose frequency is in the megahertz range. The above-described ignition circuit is DC-isolated from the operating circuit of the high-pressure discharge lamp. The operating circuit and the ignition circuit are both supplied with energy by the same push-pull inverter. For the DC isolation between the ignition circuit and the operating circuit and for the coupling to the inverter, a transformer is used having two secondary windings, of which in each case one is arranged in the ignition circuit and in the operating circuit. Once the gas discharge in the high-pressure discharge lamp has been ignited, the ignition circuit or ignition device is deactivated by means of a controllable semiconductor switch.

### II. DESCRIPTION OF THE INVENTION

The object of the invention is to provide a device of the generic type having a simplified design. This object is achieved according to the invention by the features of patent claim 1. Particularly advantageous embodiments of the invention are described in the dependent patent claims.

The device according to the invention for operating or igniting a high-pressure discharge lamp, which has been provided with an auxiliary ignition electrode, has a voltage-dependent switching means for applying the ignition voltage for the high-pressure discharge lamp to the auxiliary ignition electrode, the switching threshold voltage of the voltage-dependent switching means being greater than or equal to the ignition voltage required for igniting the gas discharge in the high-pressure discharge lamp. In this context, the ignition voltage is understood to mean the voltage required between the auxiliary ignition electrode and the associated main electrode which is necessary for igniting the gas discharge in the high-pressure discharge lamp. As a result, an ignition device for a high-pressure discharge lamp, which has been equipped with an auxiliary electrode, can be realized which manages to produce the ignition voltage pulses without the use of an ignition transformer. In addition, the controllable semiconductor switch for deactivating the ignition device once the gas discharge in the high-pressure discharge lamp has been ignited and the transformer for DC-isolating the ignition circuit and the operating circuit can also be dispensed with. The device according to the invention therefore has a simpler design than the device in accordance with the prior art.

In order to be able to produce such high voltages as are required for igniting the gas discharge in a high-pressure discharge lamp which has been provided with an auxiliary electrode, the voltage-dependent switching means preferably comprises at least one spark gap. The switching threshold voltage, i.e. the breakdown voltage of the spark gap, can be adjusted to the desired value or to a value which is greater than or equal to the ignition voltage of the high-pressure discharge lamp by changing the distance between its electrodes or by changing the pressure of the filling gas used.

Alternatively, instead of one spark gap it is also possible for a plurality of series-connected spark gaps or a spark gap which can be triggered externally with an additional ignition electrode to be used. However, instead of spark gaps it is also possible to use other voltage-dependent switching means, for example thyristors or voltage-dependent resistors or a combination of the abovementioned component parts.

Preferably, a charge storage means which can be charged to the switching threshold voltage is provided in the device according to the invention in order to provide the energy for the breakdown of the voltage-dependent switching means. The abovementioned charge storage means is preferably one or more capacitors, which are designed for high voltages.

In accordance with the preferred exemplary embodiments of the invention, the charge storage means is preferably charged to the switching threshold voltage of the voltage-dependent switching means with the aid of a resonant circuit or a voltage multiplication circuit or a piezo transformer or a combination thereof. The required high voltages of several kilovolts can be produced in a relatively simple manner by means of a resonant circuit, which is operated close to its resonance during the ignition phase, or by means of a voltage multiplication circuit. The voltage multiplication circuit can be supplied with energy, for example, via a transformer, which has been connected into the lamp circuit, or a resonant circuit.

Advantageously, a voltage convertor is provided in order to ensure the voltage supplied to the voltage-dependent switching means during the ignition phase of the high-pressure discharge lamp and to ensure the supply of current of alternating polarity to the high-pressure discharge lamp, from the system voltage, for example from the 230 volt low-voltage AC system, or from the on-board electrical system voltage of a motor vehicle. Different operating modes can be realized with the aid of the voltage convertor in order to meet the different requirements of the high-pressure discharge lamp during its ignition phase and during lamp operation once the ignition phase has come to an end. Preferably, by means of the voltage convertor, during the ignition phase of the high-pressure discharge lamp a first supply voltage is generated for the voltage-dependent switching means and, once the gas discharge in the high-pressure discharge lamp has been ignited, a second supply voltage is generated for the purpose of producing a lamp current with alternating polarity.

The voltage convertor is therefore preferably in the form of an inverter or AC voltage convertor, which can be operated at different clock or switching frequencies. For the purpose of producing the abovementioned first and second supply voltage, the inverter is preferably operated at switching frequencies from different frequency ranges. As a result, it is possible to ensure in a simple manner that, once the gas discharge in the high-pressure discharge lamp has been ignited, now only a lower voltage is present at the voltage-dependent switching means than its switching threshold voltage and therefore no further ignition voltage pulses are generated.

The device according to the invention only comprises a few components and can therefore be accommodated in the lamp base of a high-pressure discharge lamp. Therefore, the device according to the invention can be used particularly advantageously in metal-halide high-pressure discharge lamps for motor vehicle headlights which have been provided with an auxiliary ignition electrode, in particular also in mercury-free metal-halide high-pressure discharge lamps for motor vehicle headlights.

### III. DESCRIPTION OF THE PREFERRED EXEMPLARY EMBODIMENTS

The invention will be explained in more detail below with reference to a plurality of preferred exemplary embodiments. In the drawing:

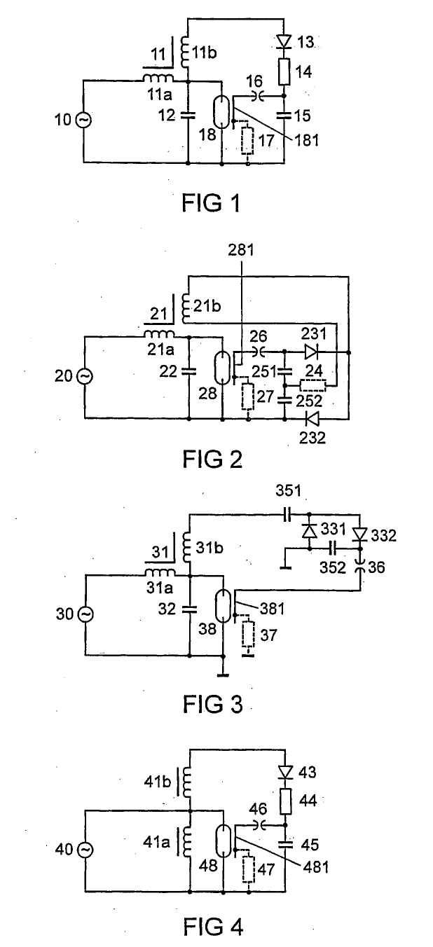

FIG. 1 shows a circuit diagram of the device in accordance with the first exemplary embodiment of the invention,

FIG. 2 shows a circuit diagram of the device in accordance with the second exemplary embodiment of the invention,

FIG. 3 shows a circuit diagram of the device in accordance with the third exemplary embodiment of the invention,

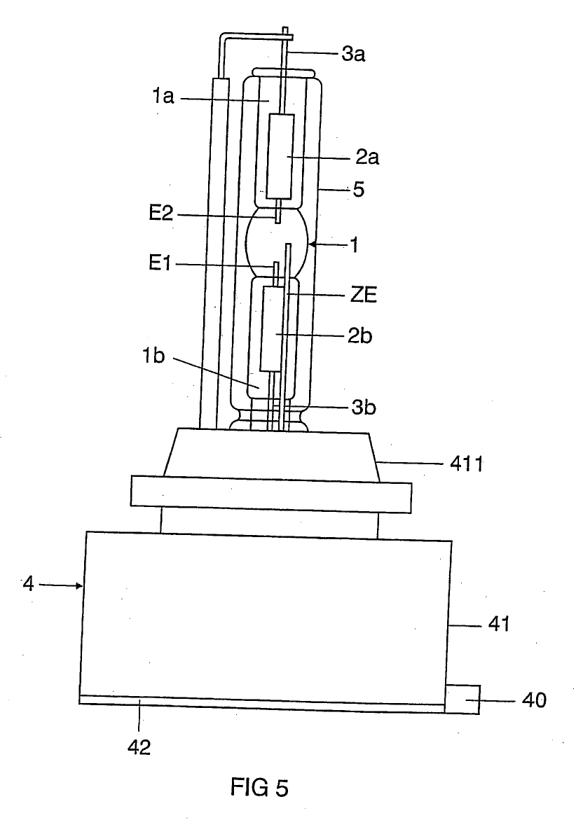

FIG. 4 shows a circuit diagram of the device in accordance with the fourth exemplary embodiment of the invention,

FIG. 5 shows a side view of the high-pressure discharge lamp operated by the devices according to the invention, in a schematic illustration, and

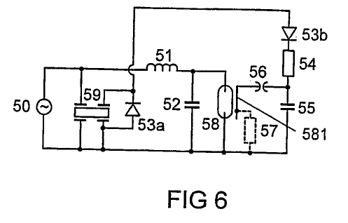

FIG. 6 shows a circuit diagram of the device in accordance with the fifth exemplary embodiment of the invention.

FIG. 1 shows, schematically, the circuit diagram of the first exemplary embodiment of the device according to the invention. The device for operating the motor vehicle headlight high-pressure discharge lamp 18, which has been provided with an auxiliary ignition electrode 181, comprises a voltage convertor 10, which generates a high-frequency AC voltage from the on-board electrical system voltage of the motor vehicle. The auxiliary ignition electrode 181, which is arranged outside of the discharge vessel of the high-pressure discharge lamp, of the high-pressure discharge lamp 18 is coupled capacitively to one of the gas discharge electrodes of the high-pressure discharge lamp 18 which are arranged within the discharge vessel. The device comprises an autotransformer 11 having a primary winding section 11a and a secondary winding section 11b, a capacitor 12, which is connected in parallel with the discharge path of the high-pressure discharge lamp 18, a rectifier diode 13, resistors 14, 17, a capacitor 15 and a spark gap 16. The diode 13 is designed for voltages of up to 30 kV, for example a diode of the type BY724. The capacitor 15 has a capacitance of 100 pF and is designed for a voltage of up to 15 kV. The resistor 17 illustrated by dashed lines in FIG. 1 is optional and can be dispensed with. It has a resistance value of 20 megaohms and can be used in particular in the case of a spark gap with a low insulation resistance, since it prevents charging of the capacitance resulting from the auxiliary ignition electrode and the main electrode. The breakdown voltage of the spark gap 16 is 12 kV. The ignition voltage required for igniting the gas discharge in the high-pressure discharge lamp 18 is typically 5 kilovolts to 10 kilovolts in the case of an off-load voltage of 2 kilovolts, measured from peak to peak. The resistance 14 limits the current through the diode 13, in particular in the case of a discharged capacitor 15, and has a resistance value of 47 kiloohms.

In order to ignite the gas discharge in the high-pressure discharge lamp 18, the voltage convertor 10 is operated at a switching frequency which is close to the resonant frequency of the series resonant circuit comprising the component parts 11a and 12. In the secondary winding section 11b of the autotransformer 11, a high voltage is thus induced which is sufficient for charging the capacitor 15, via the rectifier diode 13 and the resistor 14, to the breakdown voltage of the spark gap 16. If the voltage at the capacitor 15 reaches the breakdown voltage of the spark gap 16, it is discharged via the spark gap 16, and high voltage pulses are applied to the auxiliary ignition electrode 181 which results in the gas discharge in the high-pressure discharge lamp 18 being ignited.

Once the gas discharge in the high-pressure discharge lamp 18 has been ignited, the resonant capacitor 12 is bridged by the conductive discharge path of the high-pressure discharge lamp and the series resonant circuit is damped, so that there is no sufficiently high voltage induced in the secondary winding 11b to charge the capacitor 15 to the breakdown voltage of the spark gap 16. The ignition device is therefore automatically deactivated once the gas discharge has been ignited. In addition, the spark gap 16 therefore provides DC isolation of the auxiliary ignition electrode 181 from the device once the gas discharge has been ignited. The auxiliary ignition electrode 181 is free of potential once the ignition phase has come to an end and therefore does not cause any sodium migration, which would result in a sodium loss in the discharge vessel of the high-pressure discharge lamp 18 and therefore in premature failure of the high-pressure discharge lamp 18.

Once the ignition phase of the high-pressure discharge lamp 18 has come to an end, the switching frequency of the voltage convertor 10 is selected by means of its driving device in such a way that the high-pressure discharge lamp 18, in the case of a mercury-containing metal-halide high-pressure discharge lamp, is operated with a running voltage of approximately 85 volts and, in the case of a mercury-free metal-halide high-pressure discharge lamp, is operated with a running voltage of approximately 40 volts. The high-pressure discharge lamp 18 is fed an alternating current whose frequency is above 100 kHz. Once the ignition phase has come to an end, the capacitor 15 is charged to a voltage which is below the breakdown voltage of the spark gap 16.

FIG. 2 shows the circuit diagram of the second exemplary embodiment of the device according to the invention. The device for operating the motor vehicle headlight high-pressure discharge lamp 28, which has been provided with an auxiliary ignition electrode 281, comprises a voltage convertor 20, which generates a high-frequency AC voltage from the on-board electrical system voltage of the motor vehicle. The auxiliary ignition electrode 281, which is arranged outside of the discharge vessel of the high-pressure discharge lamp, of the high-pressure discharge lamp 28 is coupled capacitively to one of the gas discharge electrodes of the high-pressure discharge lamp 28 which are arranged within the discharge vessel. The device comprises a transformer 21 having a primary winding 21a and a secondary winding 21b, a capacitor 22, which is connected in parallel with the discharge path of the high-pressure discharge lamp 28, a spark gap 26 and resistors 24, 27 as well as a balanced voltage doubling circuit, which is formed by the diodes 231, 232 and the capacitors 251, 252. The resistors 24, 27 illustrated by dashed lines in FIG. 2 are optional.

In order to ignite the gas discharge in the high-pressure discharge lamp 28, the voltage convertor 20 is operated at a switching frequency which is close to the resonant frequency of the series resonant circuit comprising the component parts 21a and 22. As a result, a high voltage is induced in the secondary winding 21b of the transformer 21 which is increased by the abovementioned voltage doubling circuit by a factor of two, so that the capacitors 251, 252 are charged to the breakdown voltage of the spark gap 26. If the voltage at the capacitors 251, 252 reaches the breakdown voltage of the spark gap 26, said capacitors are discharged via the spark gap 26, and high voltage pulses are applied to the auxiliary ignition electrode 281 which result in the gas discharge in the high-pressure discharge lamp 28 being ignited. Once the gas discharge in the high-pressure discharge lamp 28 has been ignited, the resonant capacitor 22 is bridged by the conductive discharge path of the high-pressure discharge lamp, and the series resonant circuit is damped, so that no sufficiently high voltage is induced in the secondary winding 21b for charging the capacitors 251, 252 to the breakdown voltage of the spark gap 26. The ignition device is therefore automatically deactivated once the gas discharge has been ignited. In addition, the spark gap 26 as a result ensures DC isolation of the auxiliary ignition electrode 281 from the device once the gas discharge has been ignited.

Once the ignition phase of the high-pressure discharge lamp 28 has come to an end, the switching frequency of the voltage convertor 20 is selected by means of its driving device in such a way that the high-pressure discharge lamp 28, in the case of a mercury-containing metal-halide high-pressure discharge lamp, is operated with a running voltage of approximately 85 volts and, in the case of a mercury-free metal-halide high-pressure discharge lamp, is operated with a running voltage of approximately 40 volts. The high-pressure discharge lamp 28 is fed a virtually square-wave alternating current having a frequency of 400 hertz. Once the ignition phase has come to an end, the capacitors 251, 252 are charged to a voltage which is below the breakdown voltage of the spark gap 26. The exemplary embodiment which is explained further below and is depicted in FIG. 6, differs from the second exemplary embodiment merely by virtue of the fact that the positions of the primary winding 21a and of the resonant capacitor 22 have been swapped over in comparison with the illustration in FIG. 2. The ignition takes place in a similar manner to that in the second exemplary embodiment, whereas operation takes place with a virtually sinusoidal lamp current having a frequency of above 1 MHz, and this lamp current flows through the resonant capacitor 22.

FIG. 3 illustrates the circuit diagram of the third exemplary embodiment of the device according to the invention. The device for operating the vehicle headlight high-pressure discharge lamp 38, which has been provided with an auxiliary ignition electrode 381, comprises a voltage convertor 30, which generates a high-frequency AC voltage from the on-board electrical system voltage of the motor vehicle. The auxiliary ignition electrode 381, which is arranged outside the discharge vessel of the high-pressure discharge lamp, of the high-pressure discharge lamp 38 is coupled capacitively to one of the gas discharge electrodes of the high-pressure discharge lamp 38 which are arranged within the discharge vessel. The device comprises an autotransformer 31 having a primary winding section 31a and a secondary winding section 31b, a capacitor 32, which is connected in parallel with the discharge path of the high-pressure discharge lamp 38, a spark gap 36 and a resistor 37 as well as an unbalanced voltage doubling circuit, which is formed by the diodes 331, 332 and the capacitors 351, 352. The resistor 27 illustrated by dashed lines in FIG. 3 is optional. The diodes 331, 332 are each designed for a voltage of 25 kV. The breakdown voltage of the spark gap 36 is 22 kV. The device depicted in FIG. 3 in accordance with the third exemplary embodiment functions in a completely similar way to the device depicted in FIG. 2 in accordance with the second exemplary embodiment of the invention. Instead of the single-stage cascade circuit described here, a multi-stage cascade can be used, which is also referred to as a Cockcroft-Walton circuit.

FIG. 4 illustrates the circuit diagram of the fourth exemplary embodiment of the device according to the invention. The device for operating the vehicle headlight high-pressure discharge lamp 48, which has been provided with an auxiliary ignition electrode 481, comprises a voltage convertor 40, which generates a high-frequency AC voltage from the on-board electrical system voltage of the motor vehicle. The auxiliary ignition electrode 481, which is arranged outside of the discharge vessel of the high-pressure discharge lamp, of the high-pressure discharge lamp 48 is coupled capacitively to one of the gas discharge electrodes of the high-pressure discharge lamp 48 which are arranged within the discharge vessel. The device comprises a transformer having a primary winding 41a, which is connected in parallel with the discharge path of the high-pressure discharge lamp 48, and a secondary winding 41b, a rectifier diode 43, resistors 44, 47, a capacitor 45 and a spark gap 46. The resistor 47 illustrated by dashed lines in FIG. 4 is optional. If the transformer is designed to have sufficiently weak coupling between the primary winding and the secondary winding, it is possible to dispense with the resistor 44, in a similar manner to the resistor 24 in accordance with the embodiment illustrated in FIG. 2.

During the ignition phase of the high-pressure discharge lamp 48, a sufficiently high voltage is induced in the secondary winding 41b of the transformer to charge the capacitor 45, via the rectifier diode 43 and the resistor 44, to the breakdown voltage of the spark gap 46. If the voltage at the capacitor 45 reaches the breakdown voltage of the spark gap 46, said capacitor is discharged via the spark gap 46, and high voltage pulses are applied to the auxiliary ignition electrode 481 which result in the gas discharge in the high-pressure discharge lamp 48 being ignited.

Once the ignition phase of the high-pressure discharge lamp 48 has come to an end, the switching frequency of the voltage convertor 40 is selected by means of its driving device in such a way that the high-pressure discharge lamp 48, in the case of a mercury-containing metal-halide high-pressure discharge lamp, is operated with a running voltage of approximately 85 volts and, in the case of a mercury-free metal-halide high-pressure discharge lamp, is operated with a running voltage of approximately 40 volts. The high-pressure discharge lamp 48 is fed an alternating current whose frequency is above 100 kHz. Once the ignition phase has come to an end, the capacitor 45 is now only charged to a voltage which is below the breakdown voltage of the spark gap 46.

The high-pressure discharge lamp 18, 28, 38, 48, which is illustrated schematically in FIG. 5, in accordance with the preferred exemplary embodiments of the invention is a metal-halide high-pressure discharge lamp for a motor vehicle headlight.

This high-pressure discharge lamp La has a discharge vessel 1 consisting of quartz glass, in which an ionizable filling is enclosed in a gas-tight manner. The ionizable filling contains xenon and metal-halide compounds, preferably iodides of the metals sodium, scandium, zinc and indium, and the ionizable filling preferably does not contain any mercury. The xenon coldfilling pressure is approximately 10 bar. The two ends 1a, 1b of the discharge vessel 1 are in each case sealed off by means of a molybdenum foil fuse seal 2a, 2b. Two electrodes E1, E2 are located in the interior of the discharge vessel 1 and the discharge arc responsible for the light emission is formed between said electrodes during lamp operation. These main electrodes E1, E2 are each electrically conductively connected to a power supply line 3a, 3b, which is passed out of the discharge vessel 1, via one of the molybdenum foil fuse seals 2a, 2b. The discharge vessel 1 is enveloped by a vitreous outer bulb 5. The auxiliary ignition electrode ZE, which in FIGS. 1 to 4 is denoted by the reference symbols 181, 281, 381, 481, is in this case formed from a thin metallic coating on the inner surface of the outer bulb 5. Alternatively, this coating can also be applied to the outside of the discharge vessel 1, however. The thin metallic coating ZE has the form of an elongated strip, which extends from that end of the outer bulb 5 which is near to the base approximately as far as the level of the discharge vessel center point. The lamp vessels 1, 5 are fixed in the upper part 411, which consists of plastic, of a lamp base 4. The parallelepipedal part of the lamp base 4 is surrounded by a two-part metallic housing 41, 42, which is used for electromagnetically shielding the ignition and operating device of the high-pressure discharge lamp which is accommodated in the interior of the lamp base 4. The electrical terminal 40 of the high-pressure discharge lamp La is used for supplying voltage to the high-pressure discharge lamp and the ignition and operating device, which is arranged in the lamp base 4 and is designed in accordance with one of the preferred exemplary embodiments illustrated in FIGS. 1 to 4.

FIG. 6 illustrates, schematically, the circuit diagram of the fifth exemplary embodiment of the device according to the invention. The device for operating the vehicle headlight high-pressure discharge lamp 58, which has been provided with an auxiliary ignition electrode 581, comprises a voltage convertor 50, which generates a high-frequency AC voltage from the on-board electrical system voltage of the motor vehicle. The auxiliary ignition electrode 581, which is arranged outside of the discharge vessel of the high-pressure discharge lamp, of the high-pressure discharge lamp 58 is coupled capacitively to one of the gas discharge electrodes of the high-pressure discharge lamp 58 which are arranged within the discharge vessel. The device comprises a piezo transformer 59, whose input is fed by the voltage convertor 50 and at whose output a voltage doubler circuit comprising the diodes 53a and 53b is fed, a resonant or lamp inductor 51, which is connected in series with the voltage convertor 50 and the discharge path of the high-pressure discharge lamp, as well as a resonant capacitor 52, which is connected in parallel with the discharge path of the high-pressure discharge lamp 58, a resistor 54, a capacitor 55, a spark gap 56 and an optional resistor 57.

The diodes 53a and 53b are designed for voltages of up to 25 kV and are, for example, of the type BY724. The capacitor 15 has a capacitance of 220 pF and is designed for a voltage of up to 15 kV. The resistor 57, which is illustrated by dashed lines in FIG. 6, is optional and can be dispensed with. It has a resistance value of 100 megaohms. The breakdown voltage of the spark gap is 12 kV. The ignition voltage required for igniting the gas discharge in the high-pressure discharge lamp 58 is less than 12 kV.

In order to ignite the gas discharge in the high-pressure discharge lamp 58, the voltage convertor 50 is operated at a switching frequency which is close to the resonant frequency of the piezoelectric transformer, and in the process a high voltage is produced at its output which is rectified and increased again by the voltage doubler circuit at its output so that it is sufficient to charge the capacitor 55, via the resistor 54, to the breakdown voltage of the spark gap 56. If the voltage at the capacitor 55 reaches the breakdown voltage of the spark gap 56, it is discharged via the spark gap 56, and high voltage pulses are applied to the auxiliary ignition electrode 581 which result in the gas discharge in the high-pressure discharge lamp 58 being ignited. The component parts 51 and 52 of the series resonant circuit are in this case dimensioned such that they are close to the resonant frequency of the piezo transformer, likewise at resonance, and thus, owing to the excitation of the piezo transformer, during the ignition a sufficiently high voltage is produced between the two main electrodes of the gas discharge lamp with an amplitude of, for example, 1200 volts, and therefore the ignition of a discharge between the two main electrodes of the gas discharge lamp is made possible by the voltage pulse at the auxiliary ignition electrode 581.

Once the ignition phase of the high-pressure discharge lamp 58 has come to an end, the switching frequency of the voltage convertor 50 is selected in such a way that the high-pressure discharge lamp 58, in the case of a mercury-containing metal-halide high-pressure discharge lamp, is operated with a running voltage of approximately 85 volts and, in the case of a mercury-free metal-halide high-pressure discharge lamp, is operated with a running voltage of approximately 40 volts. The high-pressure discharge lamp 58 is fed an alternating current whose frequency is above 100 kHz. Owing to the changed frequency, the piezoelectric transformer no longer produces an output voltage which is as high, which ultimately results in the capacitor 55, once the ignition phase has come to an end, being charged to a voltage which is below the breakdown voltage of the spark gap 56.

1. A device for operating or igniting a high-pressure discharge lamp (18), which has been provided with an auxiliary ignition electrode (ZE, 181), the device having a voltage-dependent switching means (16) for applying the ignition voltage for the high-pressure discharge lamp (18) to the auxiliary ignition electrode (ZE, 181), characterized in that the switching threshold voltage of the voltage-dependent switching means (16) is greater than or equal to the ignition voltage of the high-pressure discharge lamp (18).

2. The device as claimed in claim 1, characterized in that the voltage-dependent switching means comprises at least one spark gap (16).

3. The device as claimed in claim 1, characterized in that a charge storage means (15) is provided which can be charged to the switching threshold voltage.

4. The device as claimed in claim 3, characterized in that the charge storage means comprises at least one capacitor (15).

5. The device as claimed in claim 1, characterized in that a voltage convertor (10) is provided which is used for supplying voltage to the voltage-dependent switching means (16) and to supply the high-pressure discharge lamp (18) with a current of alternating polarity.

6. The device as claimed in claim 3, characterized in that, in order to charge the charge storage means (15), a resonant circuit (11a, 12) and/or a voltage multiplication circuit (231, 232, 251, 252) and/or a piezo transformer (59) is/are provided.

7. A lamp base (4) for a high-pressure discharge lamp (18), which has been provided with an auxiliary ignition electrode (ZE, 181), with a device as claimed in claim 1.

8. A lighting system having at least one high-pressure discharge lamp, which has been provided with an auxiliary ignition electrode, and at least one device as claimed in claim 1.

9. A method for operating a high-pressure discharge lamp (18), which has been provided with an auxiliary ignition electrode (ZE, 181), voltage pulses for igniting a gas discharge in the high-pressure discharge lamp (18) being applied to the auxiliary ignition electrode (ZE, 181) by means of a voltage-dependent switching means (16), characterized in that the switching threshold voltage of the voltage-dependent switching means (16) is greater than or equal to the ignition voltage required for igniting the gas discharge in the high-pressure discharge lamp.

10. The method as claimed in claim 9, characterized in that, in order to ignite the gas discharge in the high-pressure discharge lamp (18), a charge storage means (15) is charged to the switching threshold voltage of the voltage-dependent switching means (16).

11. The method as claimed in claim 9, characterized in that, with the aid of a voltage convertor (10), during the ignition phase of the high-pressure discharge lamp (18) a first supply voltage is provided for the voltage-dependent switching means (16) and, once the gas discharge in the high-pressure discharge lamp (18) has been ignited, a second supply voltage is provided for the high-pressure discharge lamp (18), for the purpose of producing a lamp current with alternating polarity.

12. The method as claimed in claim 11, characterized in that the voltage convertor (10) is in the form of an inverter or AC voltage convertor, which is operated for the purpose of producing the first and second supply voltage with switching frequencies from different frequency ranges.

13. The method as claimed in claim 10, characterized in that, once the gas discharge in the high-pressure discharge lamp (18) has been ignited, the charge storage means (15) is charged to a voltage which is well within the switching threshold voltage of the voltage-dependent switching means (16).

14. The method as claimed in claim 10, characterized in that, with the aid of a voltage convertor (10), during the ignition phase of the high-pressure discharge lamp (18) a first supply voltage is provided for the voltage-dependent switching means (16) and, once the gas discharge in the high-pressure discharge lamp (18) has been ignited, a second supply voltage is provided for the high-pressure discharge lamp (18), for the purpose of producing a lamp current with alternating polarity.

15. The method as claimed in claim 11, characterized in that, once the gas discharge in the high-pressure discharge lamp (18) has been ignited, the charge storage means (15) is charged to a voltage which is well within the switching threshold voltage of the voltage-dependent switching means (16).

16. The method as claimed in claim 12, characterized in that, once the gas discharge in the high-pressure discharge lamp (18) has been ignited, the charge storage means (15) is charged to a voltage which is well within the switching threshold voltage of the voltage-dependent switching means (16).

17. The device as claimed in claim 2, characterized in that a voltage convertor (10) is provided which is used for supplying voltage to the voltage-dependent switching means (16) and to supply the high-pressure discharge lamp (18) with a current of alternating polarity.

18. The device as claimed in claim 3, characterized in that a voltage convertor (10) is provided which is used for supplying voltage to the voltage-dependent switching means (16) and to supply the high-pressure discharge lamp (18) with a current of alternating polarity.

19. The device as claimed in claim 4, characterized in that a voltage convertor (10) is provided which is used for supplying voltage to the voltage-dependent switching means (16) and to supply the high-pressure discharge lamp (18) with a current of alternating polarity.

20. The device as claimed in claim 5, characterized in that, in order to charge the charge storage means (15), a resonant circuit (11a, 12) and/or a voltage multiplication circuit (231, 232, 251, 252) and/or a piezo transformer (59) is/are provided.
